(19) United States
(12) Patent Application Publication
(10) Pub. No.: US 2010/0203392 A1
(43) Pub. Date: Aug. 12, 2010

(54) ELECTRODE FOR NONAQUEOUS SECONDARY BATTERY, NONAQUEOUS SECONDARY BATTERY USING THE SAME, AND METHOD FOR PRODUCING ELECTRODE

(76) Inventors: Masayuki Yamada, Osaka (JP); Hiroshi Sakurai, Osaka (JP); Kazunobu Matsumoto, Osaka (JP)

Correspondence Address: BIRCH STEWART KOLASCH & BIRCH, PO BOX 747, FALLS CHURCH, VA, 22040-0747, US

(21) Appl. No.: 12/673,963

(22) PCT Filed: Nov. 12, 2008
(86) PCT No.: PCT/JP2008/070584

§ 371 Date: Feb. 17, 2010

(30) Foreign Application Priority Data
Nov. 12, 2007 (JP) 2007-292963
Feb. 26, 2008 (JP) 2008-043698
Mar. 19, 2008 (JP) 2008-070940

(51) Int. Cl. H01M 4/62; B05D 5/12

(52) U.S. Cl. 429/232; 427/122

(57) ABSTRACT

The non aqueous secondary battery electrode of the present invention includes a mixture layer and a porous layer formed on the surface of the mixture layer. The mixture layer includes an electrode material expressed by the composition formula SiOₓ where x in the composition formula satisfies 0.5≦x≦1.5, a conductive material and at least one binder selected from the group consisting of polyimide, polyamideimide and polyamide. The porous layer includes an insulating material unreactive with Li.

### TECHNICAL FIELD

The present invention relates to a nonaqueous secondary battery electrode having a large capacity and favorable charge/discharge cycle characteristics, a nonaqueous secondary battery using the electrode, and a method of producing the electrode.

### BACKGROUND ART

High expectations have been placed on the development of nonaqueous secondary batteries due to having a high voltage and a large capacity. Nonaqueous secondary batteries employ, as a negative electrode material (negative active material), lithium (Li), a Li alloy, or a natural or artificial graphite carbon material capable of intercalating and deintercalating Li ions.

Recently, however, compact portable devices having multiple functions require higher capacity batteries. To meet such a demand, materials capable of absorbing a larger amount of Li (hereinafter also referred to as “high capacity negative electrode material”), such as low crystalline carbon, silicon (Si) and tin (Sn), are attracting a lot of attention as promising negative electrode materials.

One of the promising high capacity negative electrode materials for such nonaqueous secondary batteries is SiOₓ having a structure in which Si ultrafine particles are dispersed in SiO₂ (e.g., Patent documents 1 to 3). When this material is used as a negative active material, charging/discharging can be carried out smoothly since Si that reacts with Li is in the form of ultrafine particles. At the same time, since SiOₓ particles having the above structure have a small surface area, the material can offer excellent coating properties when used as a coating for forming a negative electrode mixture layer, and also can offer excellent adhesion between a negative electrode mixture layer and a current collector.

However, since the SiOₓ shrinks and swells greatly at the time of charging and discharging, the active material is likely to fall out or is likely to have a poor contact with a conductive agent. Consequently, the charge/discharge cycle characteristics of the battery tend to be small. Accordingly, for nonaqueous secondary batteries using SiOₓ as a negative electrode material, improvements in the charge/discharge cycle characteristics have been considered as a problem to be tackled.

For this problem, Patent document 4 proposes that by using polyimide as a binder used in a negative electrode, and subjecting the negative electrode to sintering at a temperature of 200 to 500° C. in a non-oxidative atmosphere so as to improve the adhesion between the current collector and the active material layer, falling-out of the active material and reduction in the current collection capability are prevented, and thereby the charge/discharge cycle characteristics of a nonaqueous secondary battery using Si or an Si alloy as the active material are improved.

Patent document 1: JP 2004-47404 A

Patent document 2: JP 2005-259697 A

Patent document 3: JP 2007-242590 A

Patent document 4: JP 2004-235057 A

With the technique disclosed in Patent document 4, however, the negative electrode is subjected to sintering at a high temperature, and the treatment needs to be carried out in a special environment such as in a non-oxidative softened. Further, there is a possibly that the current collector becomes softened.

Therefore, it has been required to develop techniques for producing an electrode that can exploit favorable characteristics even in a case of using an active material involving a large volume change at the time of using the battery such as the negative electrode material having a high capacity as described above.

### DISCLOSURE OF INVENTION

With the foregoing in mind, it is an object of the present invention to form, by a simple method, an electrode including a mixture layer that can withstand a stress caused by shrinking and swelling of an active material at the time of charging/discharging, and to further provide a nonaqueous secondary battery including the electrode and having a high capacity and favorable charge/discharge cycle characteristics.

The nonaqueous secondary battery electrode of the present invention includes a mixture layer and a porous layer formed on the surface of the mixture layer. The mixture layer includes an electrode material that is expressed by a composition formula SiOₓ where x in the composition formula satisfies 0.5≦x≦1.5, a conductive material, and at least one binder selected from the group consisting of polyimide, polyamideimide and polyamide. The porous layer includes an insulating material unreactive with Li.

The nonaqueous secondary battery of the present invention includes a positive electrode, a negative electrode and a nonaqueous electrolyte. The negative electrode is the nonaqueous secondary battery electrode of the present invention.

The method of producing an electrode of the present invention includes steps of applying a mixture-containing slurry containing an electrode material, a conductive material and polyamideimide to the surface of a current collector and drying the applied slurry to form a coating; forming a mixture layer by compression molding the coating; and subjecting the mixture layer to a heat treatment at a temperature of 100° C. or more and 200° C. or less.

### BRIEF DESCRIPTION OF DRAWINGS

FIG. 1 is a cross-sectional view schematically showing an electrode as an example of the nonaqueous secondary battery electrode of the present invention.

FIG. 2 is a scanning electron micrograph of a principal cross section of the electrode as an example of the nonaqueous secondary battery electrode of the present invention.

FIG. 3A is a plan view schematically showing the non aqueous secondary battery of the present invention, and FIG. 3B is a cross-sectional view schematically showing the nonaqueous secondary battery of the present invention.

FIG. 4 is a schematic view showing the appearance of the nonaqueous secondary battery of the present invention.

FIG. 5 is a graph showing charge/discharge cycle characteristics of nonaqueous secondary batteries of Examples 2 and 7 and Comparative Example 1.

FIG. 6A is an X-ray CT image of a transverse section of the nonaqueous secondary battery of Example 2 after one cycle, and FIG. 6B is an X-ray CT image of a transverse section of the nonaqueous secondary battery of Example 7 after one cycle.

### DESCRIPTION OF THE INVENTION

SiOₓ contained in the electrode of the present invention is composed principally of an oxide and has small conductivity. Thus, when using this material as a negative active material, it is necessary to include a conductive material into a negative electrode mixture layer by, for example, coating the surface of the SiOₓ particles with the conductive material or mixing the SiOₓ uniformly with the conductive material as a conductive agent so as to form a favorable conductive network in the negative electrode mixture layer. However, the volume of the SiOₓ changes greatly due to charging/discharging. Hence, if charging and discharging of the battery are repeated, the contact between the SiOₓ and the conductive material deteriorates, and thereby the capacity of the battery drops. When the amount of the conductive material is large and the amount of the SiOₓ is relatively small in the negative electrode mixture layer, an effect caused by a volume change of the SiOₓ is small. In contrast, when the amount of the SiOₓ in the negative electrode mixture layer becomes large, the above problem manifests itself remarkablely.

Thus, in the present invention, least one binder selected from the group consisting of polyimide, polyamideimide and polyamide is used in the negative electrode mixture layer so as to improve the charge/discharge cycle characteristics of the battery. This is because polyimide, polyamideimide and polyamide can bond the SiOₓ and the conductive material together more firmly in the negative electrode mixture layer, so that the contact between the SiOₓ and the conductive material can be maintained favorably even when a volume change of the SiOₓ occurs due to charging/discharging.

In particular, when using polyamideimide as the binder, unlike an electrode using polyimide as the binder, the above effects achievable by using the binder can be exerted favorably while a heat treatment at a high temperature during the production of the electrode can be circumvented. Therefore, according to the method of producing the electrode of the present invention that uses polyamideimide as the binder, it is possible to produce with ease an electrode having excellent resistance to a stress caused by shrinking and swelling of an active material.

On the other hand, even when polyamide, polyamideimide or polyamide is used as the binder in the negative electrode mixture layer, depending on the shape of the battery or the production conditions of the electrode, the negative electrode may not be able to withstand a stress caused by a volume change of SiOₓ. As a result, the entire negative electrode may become bent in the battery, and cause the battery to bulge. In particular, this problem is likely to occur in rectangular batteries whose thickness is small relative to their width.

However, by using an electrode that includes a porous layer (hereinafter, may be referred to as a “coating layer”) containing an insulating material unreactive with Li on the surface of the mixture layer, it is possible to prevent efficiently the electrode From becoming bent or an electrode body (a laminate in which a negative electrode, a positive electrode and a separator are laminated) from bulging in the thickness direction associated with a volume change of SiOₓ at the time of charging and discharging. Thus, it is possible to avoid the battery from bulging.

According to the present invention, the bending of the electrode associated with charging/discharging is prevented, and thereby the battery is prevented from bulging. Thus, a nonaqueous secondary battery having a high capacity and favorable charge/discharge cycle characteristics can be provided.

Hereinafter, a nonaqueous secondary battery that uses the nonaqueous secondary battery electrode of the present invention as a negative electrode will be described. The nonaqueous secondary battery of the present invention uses an electrode formed by laminating a mixture layer containing SiOₓ as a negative electrode material, a conductive material, and at least one binder selected from polyimide, polyamideimide and polyamide, and a coating layer for enhancing the strength of the electrode.

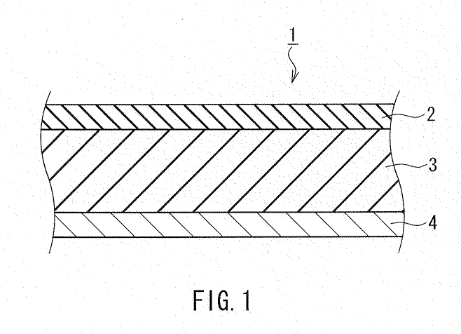

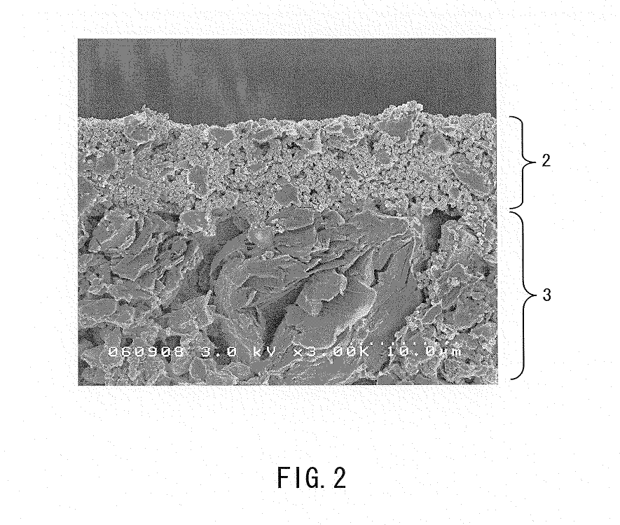

FIG. 1 is a cross-sectional view schematically showing an electrode as an example of the nonaqueous secondary battery electrode of the present invention, and FIG. 2 is a scanning electron micrograph of a principal cross section of the electrode as an example of the nonaqueous secondary battery electrode of the present invention. The nonaqueous secondary battery electrode (negative electrode) 1 of the present invention is formed by laminating a coating layer 2 for enhancing the strength of the negative electrode 1 on a mixture layer 3 containing SiOₓ, a conductive material, and at least one binder selected from polyimide, polyamideimide and polyamide. Reference numeral 4 denotes a current collector

The SiOₓ, which contains Si (silicon) and O (oxygen) (where the atomic ratio x of O to Si is 0.5≦x≦1.5) as its components and is used as the negative electrode material, may include microcrystalline Si or amorphous Si. In this case, the atomic ratio between Si and O is a ratio where the microcrystalline Si or the amorphous Si is also included in the total of Si.

That is, the negative electrode material SiOₓ includes SiOₓ having a structure in which Si (e.g., microcrystalline Si) is dispersed in an amorphous SiO₂ matrix. In this case, the atomic ratio x, including the amorphous SiO₂ and the Si dispersed in the amorphous SiO₂, preferably satisfies 0.5≦x≦1.5. For example, in the case of a composite material having a structure in which Si is dispersed in an amorphous SiO₂ matrix at a molar ratio of SiO₂ and Si of 1:1, x equals 1 (x=1). For this reason, this composite can be expressed by the composition formula SiO. When such a composite is analyzed by, for example, X-ray diffractometry, the peak attributable to Si (microcrystalline Si) may not be observed, but the presence of fine Si can be detected by a transmission electron microscopy. Further, SiO₂ may be in the form of composite particles in which SiO₂ fine particles are composited.

As the conductive material, carbon materials such as graphite, low crystalline carbon, carbon nanotube, and vapor grown carbon fiber are preferable.

And, the SiOₓ preferably is in the form of a complex in which the SiOₓ is composited with a conductive material such as a carbon material, and the surface of the SiOₓ is preferably coated with the conductive material (carbon material, etc.). As described above, SiOₓ has poor conductivity. Thus, when using SiOₓ as the negative active material, it is necessary to form a favorable conductive network by using a conductive material (a conductive agent) and favorably mixing and dispersing the SiOₓ and the conductive material in the negative electrode in terms of ensuring favorable battery characteristics. In the case of using a complex formed by compositing SiOₓ with a conductive material, a conductive network in the negative electrode can be formed more favorably than using a material obtained by simply mixing SiOₓ and a conductive material.

Examples of the complex of SiOₓ and a conductive material include, in addition to the complex in which the surface of SiOₓ is coated with a conductive material (preferably a carbon material), a granulate of SiOₓ and a conductive material (preferably a carbon material).

Further, the complex obtained by compositing the surface of SiOₓ with a conductive material (preferably a carbon material) can be further composited with a different conductive material (preferably a carbon material). Examples of such a material include a composite granulate obtained by granulating SiOₓ whose surface is coated with a conductive material with a different conductive material. Further, a composite granulate obtained by further coating the surface of a complex as a granulate of SiOₓ and a conductive material (preferably a carbon material) with a different conductive material (preferably a carbon material) also can be preferably used. By using such a composite granulate, it is possible to form a conductive network in the negative electrode more preferably, and thereby it is possible to achieve a nonaqueous secondary battery having a higher capacity and favorable battery characteristics (e.g., charge/discharge cycle characteristics). The composite granulate is preferable because when it is in a state where SiOₓ and the conductive material are dispersed uniformly it can further improve the battery characteristics such as a heavy-load

Specifically, as the above conductive material, at least one material selected from the group consisting of fibrous or coil-shaped carbon material or fibrous or coil-shaped metal, carbon black (including acetylene black and ketjen black), artificial graphite, graphitizable carbon and hardly graphitizable carbon is preferable. Fibrous or coil-shaped carbon material and fibrous or coil-shaped metal are preferable because a conductive network can be formed easily by using them, and they have a large surface area. Carbon black (including acetylene black and ketjen black), artificial graphite, easily graphitizable carbon and hardly graphitizable carbon are preferable because they have high electric conductivity and a high liquid-retaining property, and further they are likely to maintain contact with SiOₓ particles even if the SiOₓ particles shrink or swell due to charging/discharging of the battery

Among the conductive materials described above, the fibrous carbon is particularly preferable to be used to form a complex with SiOₓ when the complex is a granulate. Since the fibrous carbon has a thin thready shape and high flexibility, it can respond to shrinking and swelling of SiOₓ associated with charging/discharging of the battery. Further, since the fibrous carbon has a large bulk density, it can have many contact points with SiOₓ particles. Examples of the fibrous carbon material include polyacrylonitrile (PAN) carbon fiber, pitch carbon fiber, vapor grown carbon fiber, carbon nanotube, and the like, and any of these may be used.

Fibrous carbon material and fibrous metal also can be formed on the surface of SiOₓ particles by a vapor phase method, for example.

While the specific resistance of SiOₓ is generally 10³ to 10⁷ kΩcm, the specific resistance of each of the conductive materials described above is generally 10⁻⁵ to 10 kΩcm.

Further, the negative electrode material according to the present invention may further include a negative electrode material layer (a material layer containing hardly graphitizable carbon) for covering the surface of the negative electrode material particles.

When the negative electrode material according to the present invention is a complex of SiOₓ and a conductive material, the ratio of the conductive material to SiOₓ is preferably 5 parts by mass or more, and more preferably 10 parts by mass or more to 100 parts by mass of SiOₓ in terms of favorably exerting an effect achieved by compositing SiOₓ with the conductive material. When the ratio of the conductive material with which SiOₓ is composited is too large in the negative electrode material, it leads to a decrease in the amount of SiOₓ in the negative electrode mixture layer, which may reduce an effect of increasing the capacity. Therefore, the conductive material is preferably 50 parts by mass or less, and more preferably 40 parts by mass or less to 100 parts by mass of SiOₓ.

The negative electrode material according to the present invention can be produced using the following method, for example.

First, a production method in the case of compositing SiOₓ itself will be described. A dispersion is prepared by dispersing SiOₓ in a dispersion medium. By spraying and drying the dispersion, SiOₓ composite particles including a plurality of SiOₓ particles are produced. For example, ethanol can be used as the dispersion medium. Normally, it is adequate to carry out the spraying of the dispersion in an atmosphere of 50 to 300° C. In addition to the above method, similar SiO, composite particles can be produced by a mechanical granulation method using a vibration or planetary ball mill or rod mill.

When producing a granulate of SiOₓ and a conductive material having a lower specific resistance value than the SiOₓ, the conductive material is added to the dispersion prepared by dispersing SiOₓ in the dispersion medium. Using this dispersion, composite particles (granulate) are produced by a method similar to that used to composite SiOₓ. Further, a granulate of SiOₓ and a conductive material can be produced by a mechanical granulation method similar to that described above.

Next, when producing a complex by coating the surface of SiOₓ particles (SiOₓ composite particles or a granulate of SiOₓ and a conductive material) with a conductive material, the SiOₓ particles and a hydrocarbon gas are heated in a vapor phase, and carbon generated due to the thermal decomposition of the carbon gas is deposited on the surface of the SiOₓ particles. In this way, with chemical-vapor deposition (CVD), the hydrocarbon gas is distributed throughout the SiOₓ particles, so that a thin and uniform film containing a conductive material (e.g., a carbon material coating layer) can be formed on the surface or holes in the surface of the SiOₓ particles. Thus, it is possible to uniformly provide conductivity to the SiOₓ particles with a small amount of conductive

In the production of the SiOₓ coated with the carbon material, a treatment temperature (atmospheric temperature) of the chemical-vapor deposition (CVD) varies depending on the type of a hydrocarbon gas to be used. However, an appropriate temperature is normally 600 to 1200° C., and in particular, 700° C. or more is preferable and 800° C. or more is more preferable. This is because a higher treatment temperature results in less residual impurities and also enables to form a coating layer containing carbon having high conductivity

As the liquid source for the hydrocarbon gas, toluene, benzene, xylene, mesitylene or the like can be used. For ease of handling, toluene is particularly preferable. The hydrocarbon gas can be obtained by evaporating the liquid source (e.g., by bubbling with a nitrogen gas). Further, a methane gas or acetylene gas also can be used.

After the surface of the SiOₓ particles (SiOₓ composite particles or a granulate of SiOₓ and a conductive material) is covered with the carbon material by chemical-vapor deposition (CVD), at least one organic compound selected from the group consisting of petroleum pitch, coal pitch, thermosetting resin and a condensate of a naphthalenesulfonic acid salt and an aldehyde is adhered to the coating layer containing a carbon material, and the particles to which the organic compound is adhered may be baked.

Specifically, a dispersion prepared by dispersing the SiO, particles coated with the carbon material (SiOₓ composite particles or a granulate of SiOₓ and a conductive material) and the organic compound in a dispersion medium is sprayed and dried to form particles coated with the organic compound. The obtained particles coated with the organic compound are then baked.

An isotropic pitch can be used as the pitch. Phenol resin, furan resin or furfural resin can be used as the thermosetting resin. Naphthalene sulfate formaldehyde condensate can be used as the condensate of a naphthalenesulfonic acid salt and an aldehyde.

As the dispersion medium for dispersing the SiOₓ particles coated with the carbon material and the organic compound, for example, water or an alcohol (e.g., ethanol) can be used. Normally, it is appropriate to spray the dispersion in an atmosphere 50 to 300° C. A appropriate baking temperature is normally 600 to 1200° C., and in particular, 700° C. or more is preferable and 800° C. or more is more preferable. This is because a higher treatment temperature results in less residual impurities and also enables to form a coating layer containing a high-quality carbon material having high conductivity. However, the treatment temperature needs to be equal to or less than the melting point of SiOₓ.

The mixture layer constituting the electrode of the present invention can be formed as follows. A slurry (coating composition), which is obtained by adding an appropriate solvent (dispersion medium) to a mixture (electrode mixture) containing the negative electrode material (SiOₓ or a complex of SiOₓ and a conductive material), a binder containing at least one of polyimide, polyamideimide and polyamide, and the like, and thoroughly mixing the resultant, is applied to a current collector. The solvent (dispersion medium) is removed by drying, etc., and thereby the mixture layer is formed in a predetermined thickness and density. The mixture layer of the electrode may be formed by a method other than that described above.

Examples of polyimide include a variety of polyimides, and any of thermoplastic polyimide and thermosetting polyimide can be used. The thermoplastic polyimide may be either condensed polyimide or additional polyimide. More specifically, it is possible to use commercially-available products such as “SEMICOFINE” (trade name) manufactured by Toray Co., Ltd., “PIX SERIES” (trade name) manufactured by HD Micro Systems, Ltd., “HCI SERIES” (trade name) manufactured by Hitachi Chemicals Co., Ltd., and “U-VARNISH” (trade name) manufactured by Ube Industries, Ltd. Due to reasons such as having favorable electron movability, polyimide having an aromatic ring in its molecular chain, in other words, aromatic polyimide is more preferable. Only one kind or two or more kinds of polyimides may be used in combination.

Since polyimide has a low degree of solubility in a solvent, polyimide is generally formed by preparing a mixture-containing slurry using a solution containing polyamic acid as a polyimide precursor, applying the slurry to the surface of a current collector or the like, and imidizating the applied slurry. Therefore, when using polyimide as the binder, the treatment (the imidization treatment) at a relatively high temperature is required in the forming process of the mixture layer.

In contrast, polyamideimide does not need to be in the form of a precursor containing amic acid. Thus, it is possible to prepare a solution in a state where imidization of polyamideimide is almost or completely finished. Therefore, when polyamideimide is used as the binder, the electrode mixture layer can be formed without carrying out a heat treatment at a high temperature as required by the imidization treatment. Therefore, according to the method of producing the electrode of the present invention that uses polyamideimide as the binder, an electrode that is highly resistant to a volume change of an active material can be produced by a simple method.

Although a variety of polyamideimides can be used as the polyamideimide, polyamideimides having an aromatic ring in their molecular chain as shown in Forms 1-3 below are preferably used.

Form 1

Polyamideimide in Form 1 is an aramid-amideimide copolymer having an aramid structural unit expressed by the following formula (1) and an amideimide structural unit expressed by the following formula (2), where when the total of the aramid structural unit and the amideimide structural unit is 100 mol %, the aramid structural unit is 18 to 55 mol %.

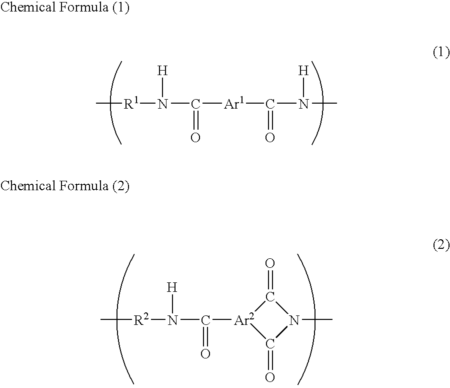

In the formula (1), Ar¹ denotes a m-phenylene group or a p-phenylene group. Further, in the formula (2), Ar² denotes a trivalent aromatic residue having one aromatic ring. Furthermore, R¹ in the formula (1) and R² in the formula (2) denote expressed by the following formulas (3) and (4), respectively. When R¹ and R² are added up, the molar ratio between the structural unit expressed by the formula (3) and the structural unit expressed by the formula (4) is 55:45 to 85:15.

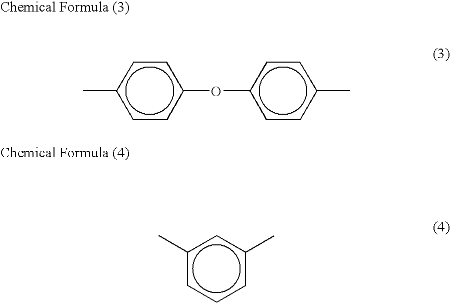

Form 2

Polyamideimide in Form 2 is an aramid-amideimide copolymer having an aramid structural unit expressed by the following formula (5) and an amideimide structural unit expressed by the following formula (6), where when the total of the aramid structural unit and the amideimide structural unit is 100 mol %, the aramid structural unit is 18 to 88 mol %.

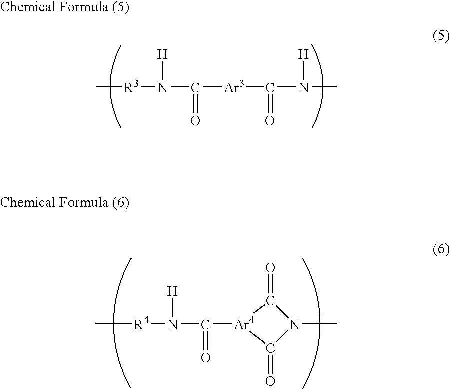

In the formula (5), Ar³ denotes a m-phenylene group or a p-phenylene group. Further, in the formula (6), Ar⁴ denotes a trivalent aromatic residue having one aromatic ring. Furthermore, R³ in the formula (5) and R⁴ in the formula (6) denote structural units expressed by the following formulas (7) and (8), respectively, and both R³ and R⁴ contain 60 mol % or more of the structural unit expressed by the formula (7). When R³ and R⁴ are added up, it is preferable that the molar ratio between the structural unit expressed by the formula (7) and the structural unit expressed by the formula (8) is 60:40 to 80:20.

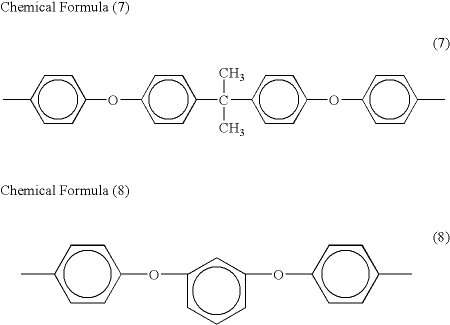

Form 3

Polyamideimide in Form 3 is polyamideimide having a structural unit expressed by the following formula (9) and a structural unit expressed by the following formula (10), where when the total of the both structural units is 100 mol %, the structural unit expressed by the formula (9) is GO to 80 mol %.

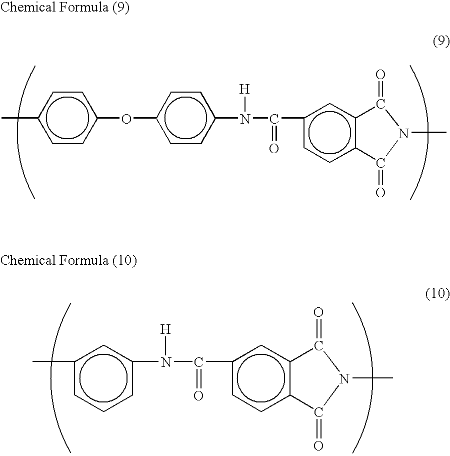

In the polyamideimide in Form 3, it is preferable that imidization has not completely finished and some parts remain in the state of polyamic acid expressed by the following formula (11). In this case, the adhesion among the respective components of the mixture layer and the adhesion between the mixture layer and the current collector further improve. In this case, the parts that remain in the state of polyamic acid can be evaluated using the amount of a remaining carboxyl group in the polyamideimide measured by a method described in JP 2007-246680 A, for example, and the amount of the remaining carboxyl group is preferably 0.05 to 0.40 mmol.

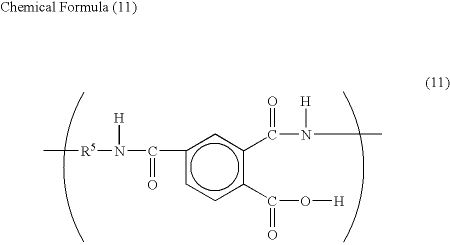

In the formula (11), R⁵ denotes the structural unit expressed by the formula (3) or the structural unit expressed by the formula (4).

In the method of producing the electrode of the present invention, in order to obtain a highly uniform mixture-containing slurry, polyamideimide is used in the form of a solution prepared by solving polyamideimide in a solvent in advance to prepare the mixture-containing slurry

As the solvent to be used in the polyamideimide solution, an aprotic polar solvent, such as N-methyl-2-pyrrolidone (NMP), N,N-dimethylformamide (DMF), N,N-dimethylacetamide (DMAC), γ-butyrolactone (GBL), dimethylsulfoxide (DMSO), or cresol is preferable, for example.

The polyamideimides (aramid-amideimide copolymer) in Forms 1 and 2 can be synthesized using an acid chloride method, for example. Specifically, it is possible to use the following method. Chloride terephthalate or chloride isophthalate and diamine constituting R in the structural units expressed by the formulas (1) and (2) are solved in an organic solvent, 100.01 to 105 mol % of the diamine is reacted with 100 mol % of the total of the chloride terephthalate or the chloride isophthalate to synthesize an amino terminal end aramid copolymer having the aramid structural unit expressed by the formula (1), the rest of the diamine is added to the amino terminal end aramid copolymer, and the copolymer is reacted with chloride tricarboxylic anhydride to synthesize a copolymer having the amideimide structural unit expressed by the formula (2).

Further, the polyamideimide in Form 3 also can be synthesized using an acid chloride method, for example. Specifically, the polyamideimide in Form 3 can be obtained by reacting raw materials including 4,4′-diaminodiphenylether and m-phenylenediamine with each other using an acid chloride method, and ring-closing (imidizing) the resultant at a temperature of 150° C. or more and 250° C. or less and a pressure of less than 30 torr.

The polyamideimides in Forms 1 to 3 are also available from Toray Co., Ltd. and Ube Industries Ltd. in the state of a solution in which each of the polyamideimides is solved in a solvent.

Further as the polyamideimide, commercially available products (solution in which polyamideimide is solved a solvent) such as “HPC SERIES” (trade name) manufactured by Hitachi Chemicals Co., Ltd. and “BIROMAX” (trade name) manufactured by TOYOBO Co., LTD. also can be used.

The polyamideimides described above may be used solely, or in combination of two or more.

A variety of polyamides, such as Nylon 66, Nylon 6, and aromatic polyamide (e.g., Nylon MXD6), can be used as the polyamide. For the same reasons as those of polyimide, polyamide having an aromatic ring in its molecular chain, in other words, aromatic polyamide is more preferable. Polyamide may be used solely, or two or more of the same may be used in combination.

Although at least one of polyimide, polyamideimide and polyamide may to be used as the binder to be used in the mixture layer, they can be used in combination of two or more.

Further, in combination with polyimide, polyamideimide or polyamide, other binder also can be used in the mixture layer. Generally, examples of the binder other than polyimide, polyamideimide and polyamide include: polysaccharides, such as starch, polyvinyl alcohol, carboxymethyl cellulose, hydroxypropyl cellulose, regenerated cellulose and diacetyl cellulose, and modified forms of these polysaccharides; thermoplastic resins, such as polyvinyl chloride, polyvinylpyrrolidone, polytetrafluoroethylene, polyvinylidene fluoride, polyethylene and polypropylene, and modified forms of these thermoplastic resins; elastic polymers, such as ethylene-propylene-dieneter polymer (EPDM), sulfonated EPDM, styrene butadiene rubber, butadiene rubber, polybutadiene, fluorocarbon rubber and polyethylene oxide, and modified forms of these elastic polymers. They can be used solely or in any combination of two or more.

A conductive material may be further added to the mixture layer as a conductive agent. As such a conductive material, any electron conductive material can be used as long as it does not cause a chemical change in the non aqueous secondary battery. Generally, examples of the conductive material include natural graphite (vein graphite, flake graphite, amorphous graphite, etc.), artificial graphite, carbon black, acetylene black, ketjen black, carbon fiber, metal powder (copper powder, nickel powder, aluminum powder and silver powder), metal fiber and polyphenylene derivative (the derivative described in JP 59-20971 A). They can be used solely or in any combination of two or more.

In the case of using the above polyamideimide as the binder in the mixture layer, an electrode can be produced as follows. A mixture-containing slurry is applied to the surface of a current corrector, the applied slurry is dried to form a coating, the coating is compression molded to form the mixture layer, and the mixture layer is subjected to a heat treatment at a temperature of 100° C. or more and 200° C. or less. The mixture-containing slurry is prepared by dispersing solids including the electrode material, the conductive material and the polyamideimide in a solvent. When needed, the solids may be dispersed in the solvent after they are mixed with each other in advance. It should be noted that it is preferable to used the polyamideimide in the state of a solution in which the polyamideimide is solved in a solvent.

Examples of the solvent used for the mixture-containing slurry include a variety of aprotic polar solvents that have been described above as preferable in solving polyamideimide.

There are no particular limitations to the method for applying the mixture-containing slurry to the current collector, and any conventional application method using a variety of coating devices (e.g., a transfer method, a doctor blade method, bay coating, etc.) can be adopted.

Also, there are no particular limitations to the drying conditions. For example, a temperature that is higher than the melting point of the solvent to be used and that does not cause deterioration of the mixture components, for example 70 to 150° C., and time during which the drying can be carried out to certain extent may be adequately selected. Further, it is possible to reduce the drying time or to lower the drying temperature by carrying out the drying under a reduced pressure (e.g., in a vacuum). The method of producing the electrode of the present invention includes a step of subjecting the electrode to a heat treatment. Thus, the solvent may remain somewhat after the drying step since it can be removed during the heat treatment.

Next, by compression molding the coating formed on the surface of the current collector as described above and adjusting the thickness, etc., the mixture layer is formed. There are no particular limitations to the method of compression molding, and conventional methods (press molding, etc.) can be adopted. Further, there are no particular limitations also to the conditions of the compression molding, and a pressure and a temperature having such magnitude that does not cause a damage to the mixture layer and the current collector and at which the mixture layer can be favorably formed may be adequately selected. For example, the compression molding can be carried out using a roll pressing machine at an ambient temperature to 100° C. and a linear load of 980 to 9800 N.

Next, the electrode on which the mixture layer is formed by compression molding is subjected to a heat treatment. In the heat treatment, a thermostat, an electric furnace or the like that can treat the electrode under a reduced pressure such as in a vacuum can be used.

The heat treatment is preferably carried out at a temperature of 200° C. or less. In the present invention, unlike the case of using polyimide, it is not necessary to carry out an imidization treatment at a high temperature after forming the mixture layer when polyamideimide is used. Thus, the heat treatment step can be carried out under moderate conditions, and thereby deterioration of the current collector and the components of the mixture layer during the heat treatment step can be prevented. The temperature of the heat treatment is preferably less than 200° C. and most preferably 190° C. or less. Further, in terms of sufficiently ensuring an effect achieved by the heat treatment, the temperature of the heat treatment is 100° C. or more, preferably 120° C. or more, and most preferably 150° C. or more.

Although the time of the heat treatment may vary depending on the components, etc., of the mixture, the time is preferably 1 to 50 hours, for example

In terms of increasing the capacity of the battery, the content of the negative electrode material (SiOₓ or a complex of SiOₓ and a conductive material) in the mixture layer is preferably 60 mass % or more and more preferably 70 mass % or more. However, when the amount of the negative electrode material in the mixture layer is too large, an effect for avoiding the problems caused by a volume change of SiOₓ may be weakened due to the amount of the binder being small, for example. Therefore, the content of the negative electrode material is preferably 99 mass % or less and more preferably 98 mass % or less.

Further, in terms of exerting more efficiently an effect achieved by using the binder, the content of the binder in the mixture layer is preferably 1 mass % or more and more preferably 2 mass % or more. However, when the amount of the binder in the mixture layer is too large, an effect of increasing the capacity may be weakened due to the amount of the negative electrode material being small, for example. Therefore, the content of the binder is preferably 30 mass % or less and more preferably 20 mass % or less.

When using other binder in combination with polyimide, polyamideimide or polyamide as the binder in the mixture layer, it is desirable to adjust the amount of the binder to satisfy the above preferable binder amount while setting the content of polyimide, polyamideimide or polyimide preferably to 1 mass % or more and more preferably to 2 mass % or more. By setting the amount of polyimide, polyamideimide or polyamide in the mixture layer as described above, the effects that can be achieved by using polyimide, polyamideimide or polyamide can be exerted more effectively.

Furthermore, in terms of further increasing the capacity of the battery, the total amount of the conductive materials (the conductive material contained in the complex of SiOₓ and the conductive material that is used solely when needed and not as a material forming a complex with SiOₓ) in the mixture layer is preferably 50 mass % or less and more preferably 40 mass % or less. Further, in terms of favorably forming a conductive network in the mixture layer, the total amount of the conductive materials in the mixture layer is preferably 5 mass % or more and more preferably 10 mass % or more.

The thickness of the mixture layer is preferably 10 to 100 for example.

The method of producing the electrode of the present invention is not invited to producing an electrode having the above-described negative electrode material, and it can be used to produce an electrode having a negative electrode material or a positive electrode material such as Sn, Sn alloy, Sn oxide, carbon material or lithium-titanium oxide, which is likely to cause the problems associated with shrinking and swelling. Also, the method can be used to produce not only secondary batteries but also primary batteries.

In the electrode of the present invention, it is desirable to form a coating layer on the surface of the mixture layer in order to improve the bending strength and the tensile strength of the electrode itself, so that the electrode is prevented from swelling or becoming bent due to shrinking and swelling of the negative electrode material to a greatly degree associated with charging/discharging.

The coating layer is a porous layer containing an insulating material unreactive with Li and having pores that allow a nonaqueous electrolyte (electrolytic solution) to pass through.

Examples of the insulating material unreactive with Li for forming the coating layer include a variety of inorganic fine particles and organic fine particles. As the inorganic fine particles, a chalcogenide (oxide, sulfide, etc.), nitride, carbide or silicide of a metal element or nonmetallic element is preferable.

As the chalcogenide of a metal element or nonmetallic element, an oxide is preferable, and an oxide that is difficult to reduce is more preferable. Examples of such an oxide include boehmites including Al₂O₃ and AlOOH, MgO, CaO, SrO, BaO, ZrO₂, ZnO, B₂O₃, Ga₂O₃, In₂O₃, SiO₂, As₄O₆ and Sb₂O₅. In particular, boehmites including Al₂O₃ and AlOOH, ZnO, Ga₂O₃, SiO₂ and ZrO₂ are preferable. These oxides may be a simple compound or composite compound.

Aluminum oxides (boehmites including Al₂O₃ and AlOOH) are particularly preferable as the insulting material unreactive with Li. This is because they have a high degree of insulation and are chemically stable.

As the nitride of a metal element or nonmetallic element, aluminum nitride (AlN) or BN can be used. As the carbide or silicide of a metal element or nonmetallic element, SiC can be used. These materials are preferable because they have a high degree of insulation and are chemically stable.

As the organic fine particles serving as the insulting material unreactive with Li for forming the coating layer, those that are not fluidized to form a film or do not decompose at a temperature of 300° C. or less are preferable. For example, fine particles of a fluoroplastic such as polytetrafluoroethylene (PTFE) or a cross-linked latex can be used.

The particle size of the insulating material unreactive with Li is preferably 0.1 μm or more and 10 μm or less, and more preferably 0.2 μm or more and 5 μm or less. The particle size can be measured by a laser diffraction particle distribution measurement method, which will be described later.

The average particle size of the insulating material unreactive with Li is preferably 0.2 μm or more and 5 μm or less.

The coating layer may contain an electron conductive material. Although an electron conductive material is not an essential component of the coating layer, it is included in the coating layer when Li is introduced in the SiOₓ of the negative electrode in advance, as will be described later.

Examples of the electron conductive material usable in the coating layer include carbon material such as carbon particles and carbon fiber, metal materials such as metal particles and metal fiber and metal oxides. In particular, carbon particles and metal particles having a low degree of reactivity with Li are preferable.

As the carbon material, any carbon material that has been used as a conductive agent in the electrode constituting a battery can be used. Specific examples include carbon particles such as carbon black (thermal black, furnace black, channel black, lamp black, ketjen black, acetylene black, etc.), graphite (natural graphite including flake graphite and amorphous graphite, and artificial graphite) and carbon fiber.

Among the above carbon materials, a combined use of carbon black and graphite is particularly preferable in terms of dispersibility with a binder, which will be described later. As the carbon black, ketjen black or acetylene black is particularly preferable.

The particle size of the carbon particles is preferably 0.01 μm or more and 10 μm or less, and more preferably 0.02 μm or more and 5 μm or less.

The metal particles or metal fibers usable as the electron conductive material for forming the coating layer preferably are made of a metal element having a low degree of reactivity with Li and are less likely to form an alloy with Li. Examples of the metal element for forming the metal particles or metal fibers include Ti, Fe, Ni, Cu, Mo, Ta and W.

When using the metal particles, there are no particular limitations to their shape. The metal particles can have any shape such as a cluster shape, needle-like shape, columnar shape or plate-like shape. Preferably, the surface of the metal particles or metal fibers is not excessively oxidized. If the surface of the metal particles or metal fibers is excessively oxidized, it is preferable to subject the metal particles or metal fibers to a heat treatment in a reducing atmosphere in advance to be used in forming the coating layer. This is because electron conductivity drops when the surface is oxidized, and thereby sufficient conductivity cannot be achieved.

The particle size of the metal particles is preferably 0.02 μm or more and 10 μm or less, and more preferably 0.1 μm or more and 5 μm or less.

For the formation of the coating layer, it is preferable to use a binder to bind the insulating material unreactive with Li and the electron conductive material. As the binder, a variety of materials that have been described above as useable as the binder in the mixture layer can be used. When at least one or more of polyimide, polyamideimide and polyamide are used as the binder in the coating layer, the adhesion between the mixture layer and the coating layer improves.

When using a binder in forming the coating layer, the content of the binder in the coating layer is preferably 2 mass % or more and 60 mass % or less, and more preferably 4 mass % or more and 50 mass % or less.

In the case of including the electron conductive material in the coating layer, when the total mass of the insulating material unreactive with Li and the electron conductive material is 100 mass %, the ratio of the electron conductive material is preferably 2.5 mass % or more and 96 mass % or less, and more preferably 5 mass % or more and 95 mass % or less, for example. In other words, the ratio of the insulating material unreactive with Li is preferably 4 mass % or more and 97.5 mass % or less, and more preferably 5 mass % or more and 95 mass % or less, for example.

The thickness of the coating layer is preferably 1 μm or more and 10 μm or less, more preferably 2 μm or more and 8 μm or less, and most preferably 3 μm or more and 5 μm or less. As long as the coating layer has such a thickness, it is possible to prevent the mixture layer from swelling or becoming bent more effectively, and an increase in capacity of the battery and improvements in battery characteristics can be achieved with more certainty. That is, when the thickness of the coating layer is much thinner relative to the surface roughness of the mixture layer, it is difficult to cover the entire surface of the mixture layer without creating pinholes, and thus the effect achieved by forming the coating layer may be reduced. On the other hand, when the coating layer is too thick, it can lead to a reduction in the battery capacity. For this reason, it is preferable to form the coating layer as thin as possible.

By forming the coating layer, the affinity between the electrode and the nonaqueous electrolyte improves. Thus, the effect of efficiently introducing a nonaqueous electrolyte into the battery can be expected.

The coating layer can be formed in a predetermined thickness by applying a slurry (coating composition) prepared by thoroughly mixing a mixture containing the insulating material unreactive with Li, the electron conductive material used when needed, the binder and the like with an appropriate solvent (dispersion medium) onto the surface of the mixture layer, followed by drying to remove the solvent (dispersion medium). The coating layer may be formed by a method other than the above method. For example, the mixture layer and the coating layer can be formed simultaneously by applying the slurry for forming the mixture layer onto the surface of a current collector, after which the slurry for forming the coating layer is applied thereon before the formed coating of the slurry for forming the negative electrode material mixture layer is dried completely. Furthermore, the slurry for forming the mixture layer and the slurry for forming the coating layer may be applied one by one in sequence.

On the other hand, SiOₓ constituting the negative electrode material has a relatively high irreversible capacity, so that dischargeable capacity may become smaller than a chargeable capacity. Thus, in the electrode according to the present invention, it is preferable to introduce Li in the negative electrode material in advance. In this case, the capacity can be further increased.

As a method of intercalating Li in the negative electrode material, it is preferable that an Li-containing layer is formed on the surface of the coating layer containing an electron conductive material opposite to the mixture layer and Li is introduced in SiOₓ in the mixture layer from the Li-containing layer.

When intercalating Li in SiOₓ, unless Li is introduced uniformly throughout the mixture layer, the electrode becomes likely to be bent due to a volume change of SiOₓ. However, by forming the coating layer on the surface of the mixture layer, the reaction between SiOₓ and Li can be controlled, and thereby bending of the electrode associated with the intercalation of Li can be avoided.

The Li-containing layer for intercalating Li in the electrode preferably is formed by a general vapor phase method (vapor deposition) such as resistance heating or spattering. By directly forming the Li-containing layer on the surface of the coating layer as a vapor deposition film by a vapor phase method, a uniform layer can be formed throughout the coating layer in a desired thickness with ease. Thus, an appropriate amount of Li necessary to compensate the irreversible capacity of SiOₓ can be introduced.

When forming the Li-containing layer by a vapor phase method, a deposition source and the coating layer of the electrode are brought to face each other in a vacuum chamber and the Li-containing layer is deposited until it obtains a predetermined thickness.

The Li-containing layer may be formed solely by Li or a Li alloy such as Li—Al, Li—Al—Mn, Li—Al—Mg, Li—Al—Sn, Li—Al—In or Li—Al—Cd. When the Li-containing layer is formed by a Li alloy, the content of Li in the Li-containing layer preferably is 50 to 90 mol %, for example.

The thickness of the Li-containing layer is preferably 0.5 μm or more and 10 μm or less, more preferably 2 μm or more and 8 μm or less and most preferably 4 μm or more, for example. By forming the Li-containing layer in such a thickness, an appropriate amount of Li necessary to compensate the irreversible capacity of SiOₓ can be introduced. In other words, when the Li-containing layer is too thin, the amount of Li becomes small relative to the amount of SiOₓ present in the mixture layer, and the effect of increasing the capacity may be reduced. Conversely, when the Li-containing layer is too thick, the amount of Li may become excessive. In addition, because the amount of deposited Li increases, the productivity drops.

For the positive electrode of the battery according to the present invention, a Li-containing transition metal oxide may be used as a positive electrode material (positive active material). Specific examples of the Li-containing transition metal oxide include Liₓ CoO₂, LiₓNiO₂, Liₓ MnO₂, Liₓ CO_{y} Ni_{1-y} O₂, Liₓ CO_{y} M_{1-y} O₂, Liₓ Ni_{1-y} M_{y} O₂, Liₓ Mn_{y} Ni_{z} Co_{1-y-z} O₂, Liₓ Mn₂O₄, Liₓ Mn_{2-y} M_{y} O₄ and the like (in the formula, M denotes at least one metal element selected from the group consisting of Mg, Mn, Fe, Co, Ni, Cu, Zn, Al, Ti, Ge and Cr, and 0≦x≦1.1, 0<y<1.0, and 2.0<z<1.0).

The positive electrode can be obtained by applying a positive electrode mixture-containing composition in the form of a paste or slurry prepared by thoroughly mixing a mixture (positive electrode mixture) containing the positive electrode material, a conductive agent and a binder with an appropriate solvent (dispersion medium) onto a current collector to form a mixture layer having a predetermined thickness and a predetermined density. The method of producing the positive electrode is not limited to the above method, and it may be produced by a method other than the above method.

As the binder for the positive electrode, any of those described above as the binder for the negative electrode can be used. Likewise, as the conductive agent for the positive electrode, any of those described above as the conductive agent for the negative electrode can be used.

In the mixture layer of the positive electrode, the content of the positive electrode material (positive active material) preferably is 79.5 to 99 mass %, for example. The content of the binder preferably is 0.5 to 20 mass %, for example. The content of the conductive agent preferably is 0.5 to 20 mass %, for example.

As the nonaqueous electrolyte to be used for the battery of the present invention, an electrolytic solution prepared by dissolving the following inorganic ion salt in the following solvent can be used.

As the solvent, an aprotic organic solvent, such as ethylene carbonate (EC), propylene carbonate (PC), butylene carbonate (BC), dimethyl carbonate (DMC), diethyl carbonate (DEC), methyl ethyl carbonate (MEC), γ-butyrolactone, 1,2-dimethoxyethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, phosphoric acid triester, trimethoxymethane, derivative, sulfolane, 3-methyl-2-oxazolidinone, propylene carbonate derivative, tetrahydrofuran derivative, diethyl ether and 1,3-propanesultone can be used, for example. They can be used solely or in any combination of two or more.

Examples of the inorganic ion salt include LiClO₄, LiBF₄, LiPF₆, LiCF₃SO₃, LiCF₃CO₂, LiAsF₆, LiSbF₆, LiB₁₀Cl₁₀, lithium lower aliphatic carboxylate, LiAlCl₄, LiCl, LiBr, LiI, lithium chloroborate and lithium tetraphenylborate. They can be used solely or in any combination of two or more.

Among the electrolytic solutions prepared by dissolving the inorganic ion salt in the above solvent, an electrolytic solution prepared by dissolving at least one inorganic ion salt selected from the group consisting of LiClO₄, LiBF₄, LiPF₆, and LiCF₃SO₃ in a solvent containing ethylene carbonate or propylene carbonate and at least one selected from the group consisting of 1,2-dimethoxyethane, diethyl carbonate and methyl ethyl carbonate is preferable. An appropriate concentration of the inorganic ion salt in the electrolytic solution is 0.2 to 3.0 mol/dm³, for example.

The nonaqueous secondary battery of the present invention can be obtained by assembling the battery using the positive electrode, the negative electrode and the nonaqueous electrolyte described above.

As long as the nonaqueous secondary battery of the present invention includes the negative electrode, the positive electrode and the non aqueous electrolyte described above, there are no particular limitations to other components and its structure, and a variety of components and structures having been adopted in conventional nonaqueous secondary batteries can be applied to the nonaqueous secondary battery of the present invention.

For example, as the separator, a separator having sufficient strength and capable of retaining a large amount of electrolytic solution is preferable. From this point of view, a microporous film or non-woven fabric containing polyethylene, polypropylene or an ethylene-propylene copolymer and having a thickness of 10 to 50 μm and a porosity of 30 to 70% is preferable.

In the nonaqueous secondary battery of the present invention, there are no particular limitations to its shape. It may have any shape such as a coin shape, button shape, sheet shape, laminate type, cylindrical shape, flat shape, rectangular shape or large type as used for electric vehicles, etc.

Further, in accordance with the form of the nonaqueous secondary battery, the positive electrode, the negative electrode and the separator can be introduced into the battery in the formed of an electrode body with a laminate structure obtained by laminating a plurality of the positive electrodes and a plurality of the negative electrodes with a separator being interposed therebetween or an electrode body with a spiral structure obtained by laminating the positive electrode and the negative electrode with the separator being interposed therebetween and further winding them spirally.

The nonaqueous secondary battery of the present invention has a large capacity and a variety of favorable battery characteristics including charge/discharge cycle characteristics. By making full use of these characteristics, the non aqueous secondary battery of the present invention can be preferably used for a variety of application purposes, including a power supply for small and multifunctional portable devices, for which conventional nonaqueous secondary batteries have been used.

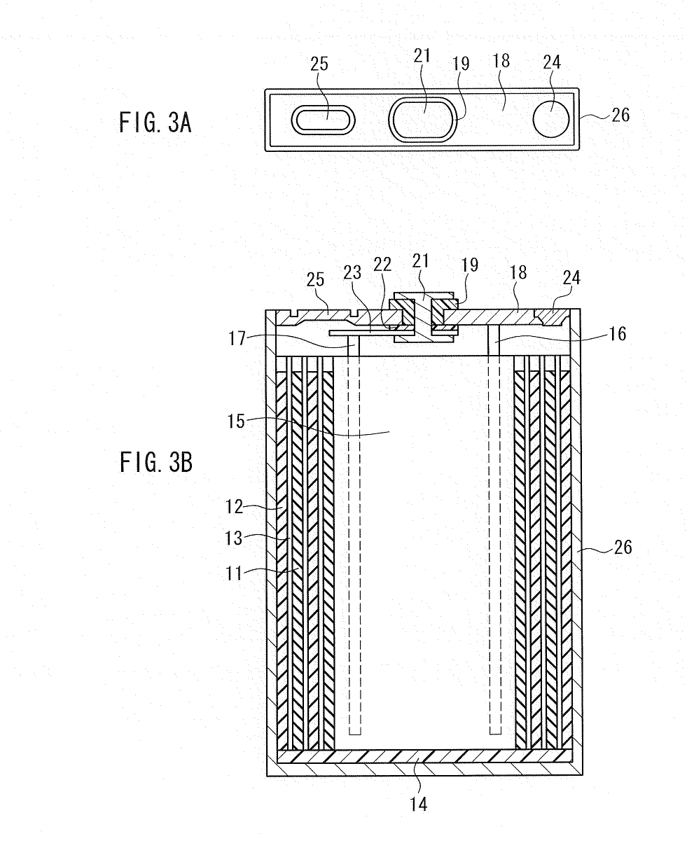

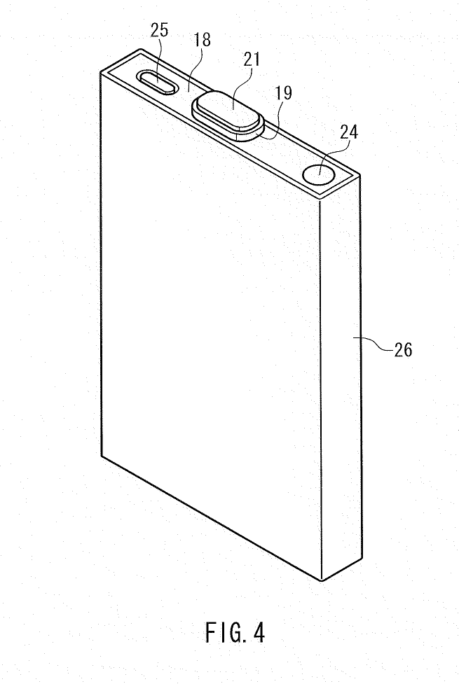

Hereinafter, an example of the nonaqueous secondary battery of the present invention will be described with reference to the drawings. FIG. 3A is a plan view schematically showing the nonaqueous secondary battery of the present invention, and FIG. 3B is a cross-sectional view schematically showing the nonaqueous secondary battery of the present invention. FIG. 4 is a schematic view showing the appearance of the nonaqueous secondary battery of the present invention.

With respect to the battery shown in FIGS. 3A, 3B and 4, each negative electrode 11 and each positive electrode 12 are wound spirally through a separator 13 therebetween, and are further pressurized to be flat. They form a wound electrode body 15 and are contained in an outer can 26 having a cylindrical shape with angles together with a nonaqueous electrolyte. In FIG. 3B, however, metal foils as current collectors for each of the negative electrodes 11 and the positive electrodes 12 and the nonaqueous electrolyte are not shown for the sake of brevity, and the central portion of the wound electrode body 15 and the separators 13 are not denoted with hatching that indicates a cross section.

The outer can 26 is made of aluminum alloy, and forms an outer package of the battery. The outer can 26 also serves as a positive electrode terminal. An insulator 14 made of a polyethylene sheet is disposed on the bottom of the outer can 26, and negative electrode lead portions 17 and positive electrode lead portions 16, which are respectively connected to one end of the negative electrodes 11 and that of the positive electrodes 12, are pulled out from the wound electrode body 15 composed of the negative electrodes 11, the positive electrodes 12, and the separators 13. To a cover plate 18 made of aluminum alloy for sealing an opening portion of the outer can 26, a terminal 21 made of stainless steel is attached through an insulating packing 19 made of polypropylene. To the terminal 21, a lead plate 23 made of stainless steel is attached through an insulator 22.

The cover plate 18 is inserted in the opening portion of the outer can 26. By welding the junction of the cover plate 18 and the opening portion, the opening portion of the outer can 26 is sealed and also the inside of the battery is sealed. The cover plate 18 is provided with a nonaqueous electrolyte inlet 24. The nonaqueous electrolyte inlet 24 is sealed by laser beam welding while a sealing member is inserted therein so as to ensure the sealing of the battery. In FIGS. 3A, 3B and 4, the illustration of the nonaqueous electrolyte inlet 24 includes both the nonaqueous electrolyte inlet itself and the sealing member for the sake of convenience. Furthermore, the cover plate 18 is provided with a cleavage vent 25 as a mechanism for letting out gas in the battery when the internal pressure rises due to an increase in the temperature of the battery

In the nonaqueous secondary battery shown in FIGS. 3A, 3B and 4, the outer can 26 and the cover plate 18 function as a positive electrode terminal by welding the positive electrode lead portions 16 directly to the cover plate 18, and the terminal 21 functions as a negative electrode terminal by welding the negative electrode lead portions 17 to a lead plate 23 and conducting the negative electrode lead portion 17 and the terminal 21 through the lead plate 23. However, depending on the material, etc., of the outer can 26, the positive and the negative may be reversed.

Next, the present invention will be described in detail on the basis of examples. The present invention, however, is not limited to the following examples. In the following examples, the average particle size of each of composite particles, α-alumina and graphite is a volume average measured by a laser diffraction particle distribution measurement method using “MICROTRAC HRA (Model: 9320-X100) manufactured by MICROTRAC Co., Ltd.

### Example 1

SiO particles (average particle size: 5.0 μm) as a negative active material were heated to about 1000° C. in an ebullated bed reactor to bring the heated SiO particles into contact with a mixed gas of methane and a nitrogen gas with a temperature of 25° C. for CVD treatment at 1000° C. for 60 minutes. The carbon (hereinafter also referred to as “CVD carbon”) produced by thermal decomposition of the mixed gas was deposited onto the SiO particles to form a coating layer thereon. Thereby, a negative electrode material was obtained.

The composition of the negative electrode material was determined from a change in mass before and after the formation of the coating layer and found to be SiO:CVD carbon=85:15 (mass ratio).

Subsequently, using the negative electrode material, a negative electrode precursor sheet was produced in the following manner. A negative electrode mixture-containing slurry was prepared by mixing the negative electrode material in an amount of 80 mass % (mass percentage relative to the total amount of solids in the slurry, hereinafter the same) with 10 mass % of graphite, 2 mass % of ketjen black (average particle size: 0.05 μm) as a conductive agent, 8 mass % of polyamideimide as a binder and dehydrated N-methylpyrrolidone (NMP).

Using a blade coater, the negative electrode mixture-containing slurry was applied onto the both surfaces of a current collector composed of a copper foil having a thickness of 8 μm. The current collector was then dried at 100° C. and compression molded by a roller press so as to form negative electrode mixture layers each having a thickness of 35 μm respectively on the both surfaces of the current collector to produce a laminate.

The laminate was further subjected to a heat treatment at 160° C. for 15 hours using a far-infrared heater, and then the laminate was cut, and strip-shaped negative electrodes each having a width of 37 mm and a length of 460 nm were obtained. In each of the negative electrodes after the heat treatment, the adhesion between the negative electrode mixture layer and the current collector was strong. Thus, the negative electrode mixture layer did not peel off the current collector even by the cutting and bending.

Positive electrodes were produced in the following manner. First, a positive electrode mixture-containing slurry was prepared by mixing 96 mass % (mass percentage relative to the total amount of solids in the slurry, hereinafter the same) of LiCoO₂ as a positive electrode material, 2 mass % of ketjen black (average particle size: 0.05 μm) as a conductive agent, 2 mass % of PVDF as a binder and dehydrated NMP. The slimy was then applied onto the both surfaces of a current collector composed of an aluminum foil having a thickness of 15 μm, which was then dried and pressed to form positive electrode mixture layers having a thickness of 85 μm respectively on the both surfaces of the current collector to produce a laminate. Then, the laminate was cut, and strip-shaped positive electrodes each having a width of 36 mm and a length of 460 mm were obtained.

Next, the negative electrodes, separators made of a microporous polyethylene film and the positive electrodes were wound spirally, and a terminal was welded thereto. They were placed in a positive electrode can made of aluminum and having a thickness of 4 mm, a width of 34 mm and a height of 43 mm (463443 type), and a cover was attached to the can by welding. Then, 2.5 g of an electrolyte solution (nonaqueous electrolyte) prepared by solving 1 mol of LiPF₆ in a solvent (EC:DEC=3:7 (volume ratio)) was poured into the positive electrode can from an inlet provided on the lid. By sealing the positive electrode can, a rectangular nonaqueous secondary battery was obtained.

### Example 2

A slurry for forming a coating layer was prepared by mixing 96 mass % (mass percentage relative to the total amount of solids in the slurry, hereinafter the same) of α-alumina (average particle size: 1 μm) as an insulating material unreative with Li, 4 mass % of polyvinylidene fluoride (PVDF) and dehydrated NMP.

Using a blade coater, the negative electrode mixture-containing slurry of Example 1 and the slurry for forming a coating layer were applied onto the both surfaces of a current collector composed of a copper foil having a thickness of 8 μm such that the negative electrode mixture-containing slurry of Example 1 served as the lower layer and the slurry for forming a coating layer served as the upper layer. Then, the current collector was dried at 100° C., and then compression molded by a roller press so as to form laminates each including a negative electrode mixture layer having a thickness of 35 μm and a coating layer having a thickness of 5 μm on the both surfaces of the current collector. Next, the current collector with the laminates being formed thereon was dried at 100° C. in a vacuum for 15 hours.

The laminates were further subjected to a heat treatment at 160° C. for 15 hours using a far-infrared heater. In each of the laminates after the heat treatment, the adhesion between the negative electrode mixture layer and the current collector and the adhesion between the negative electrode mixture layer and the coating layer were strong, so that the negative electrode mixture layer did not peel off the current collector and also the coating layer did not peel off the negative electrode mixture layer even by the cutting or bending. From then on, a nonaqueous secondary battery was produced in the same manner as that in Example 1.

### Example 3

200 g of SiO (average particle size: 1 μm), 60 g of graphite (average particle size: 3 μm) and 30 g of polyethylene resin particles as a binder were placed in a container made of stainless steel and having a capacity of 4 L, and the container was further placed in a bowl made of stainless steel, and the SiO, the graphite and the polyethylene resin particles were mixed, pulverized, and granulated for 3 hours using a vibrating mill. As a result, composite parades (composite particles of SiO and graphite) having an average particle size of 20 μm were prepared. Then, the composite parades were heated to about 950° C. in an ebullated bed reactor to bring the heated composite particles into contact with a mixed gas of toluene and a nitrogen gas with a temperature of 25° C. for CVD treatment at 950° C. for 60 minutes. In this way, the carbon produced by thermal decomposition of the mixed gas was deposited onto the composite particles to form a coating layer thereon. Thereby, a negative electrode material was obtained.

The composition of the negative electrode material was determined from a change in mass before and after the formation of the coating layer and found to be SiO:graphite:CVD carbon=60:25:15 (mass ratio).

Subsequently, a negative electrode mixture-containing slurry was prepared by mixing the negative electrode material in an amount of 90 mass % (mass percentage relative to the total amount of solids in the slurry hereinafter the same) with 2 mass % of ketjen black (average parade size: 0.05 μm) as a conductive agent, 8 mass % of polyamideimide as a binder and dehydrated NMP. The negative electrode was prepared in the same manner as that in Example 1 except that the above negative electrode mixture-containing slurry was used to form a negative electrode mixture layer. Furthermore, a nonaqueous secondary battery was produced in the same manner as that in Example 1 except that the above electrode was used.

### Example 4

A negative electrode was produced in the same manner as that in Example 3 except that the negative active material was changed from SiO to Si. Furthermore, a nonaqueous secondary battery was produced in the same manner as that in Example 3 except that this electrode was used.

### Example 5

A slurry was obtained by mixing SiO (average particle size: 1 μm) as a negative active material, fiberous carbon (average length: 2 μm, average diameter: 0.08 μm) and 10 g of polyvinylpyrrolidone with 1 L of ethanol, and further mixing the resultant using a wet jet mill. The total mass of the SiO and the fiberous carbon (CO used in the preparation of the slurry was set to 100 g and the mass ratio was set to SiO:CF=80:20. Next, composite particles of SiO and CF were prepared using the slurry by a spray dry method (atmospheric temperature: 200° C.). The average particle size of the composite particles was 10 μm. Then, the composite particles were heated to about 1000° C. in an ebullated bed reactor to bring the heated composite particles into contact with a mixed gas of benzene and a nitrogen gas with a temperature of 25° C. for CVD treatment at 1000° C. for 60 minutes. In this way, the carbon (CVD carbon) produced by thermal decomposition of the mixed gas was deposited onto the composite particles to form a coating layer thereon. Thereby, a negative electrode material was obtained.

The composition of the negative electrode material was determined from a change in mass before and after the formation of the coating layer and found to be SiO:CF:CVD carbon=68:17:15 (mass ratio).

Subsequently, a negative electrode mixture-containing slurry was prepared by mixing the negative electrode material in an amount of 90 mass % (mass percentage relative to the total amount of solids in the slurry, hereinafter the same) with 2 mass % of ketjen black (average particle size: 0.05 μm) as a conductive agent, 8 mass % of polyamideimide as a binder and dehydrated NMP. The negative electrode was prepared in the same manner as that in Example 2 except that the above negative electrode mixture-containing slurry was used to form a negative electrode mixture layer. Furthermore, a nonaqueous secondary battery was produced in the same manner as that in Example 2 except that the above electrode was used.

### Example 6

Using a slurry containing SiO (average particle size: 1 μm) as a negative active material and graphite (average particle size: 2 μm), composite particles of the SiO and the graphite were prepared in the same manner as that in Example 5. The mass ratio between the SiO and the graphite in the slurry was 90:10, and the average particle size of the composite particles was 15 μm. Then, carbon was deposited onto the composite particles to form a coating layer in the same manner as that in Example 5, the composite particles having a carbon coating layer were obtained. Further, 100 g of the composite particles and 40 g of a phenolic resin were dispersed in 1 L of ethanol, and the dispersion was sprayed and dried (atmospheric temperature: 200° C.) to further coat the surface of the composite particles having a carbon coating layer with the phenolic resin. Next, the composite particles were baked at 1000° C. to form a material layer containing hardly graphitizable carbon on the carbon coating layer, and thereby a negative electrode material was obtained.

The composition of the negative electrode material was determined from a change in mass of the material in each of the steps and found to be SiO:graphite:CVD carbon: hardly graphitizable carbon=63:7:15:15 (mass ratio).

Subsequently, a negative electrode mixture-containing slurry was prepared by mixing the negative electrode material in an amount of 90 mass % (mass percentage relative to the total amount of solids in the slurry, hereinafter the same) with 2 mass % of ketjen black (average particle size: 0.05 nm) as a conductive agent, 8 mass % of polyamideimide as a binder and dehydrated NMP. The negative electrode was produced in the same manner as that in Example 2 except that the above negative electrode mixture-containing slurry was used to form a negative electrode mixture layer. Furthermore, a nonaqueous secondary battery was produced in the same manner as that in Example 2 except the above electrode was used.

### Example 7

A negative electrode was produced in the same manner as that in Example 1 except that the binder in the negative electrode mixture was changed to polyimide and the temperature of the heat treatment to which the negative electrode mixture layer was subjected was set to 220° C. Furthermore, a nonaqueous secondary battery was produced in the same mariner as that in Example 1 except that this negative electrode was used.

### Comparative Example 1

A negative electrode was produced in the same manner as that in Example 1 except that the binder in the negative electrode mixture was changed to polyvinylidene fluoride (PVDF). Furthermore, a nonaqueous secondary battery was produced in the same manner as that in Example 1 except that this electrode was used.

The batteries of Examples 1 to 7 and Comparative Example 1 were evaluated on the following points: a change in thickness at the time of charging; discharge capacity; and a capacity retention rate at each charge/discharge cycle.

For charging of the batteries, constant current-constant voltage charging (current value at constant current charging: 400 mA, voltage at constant voltage charging: 4.2 V) was employed, and the charging was ended when the current value at the constant voltage charging dropped to 40 mA.

For discharging, constant current discharging (current value: 400 mA) was employed and an-end-of-discharge voltage was set to 2.5 V. A series of the charging and the discharging operations were defined as one cycle and the discharge capacity at a second cycle was defined as the discharge capacity of the batteries. The rate of the discharge capacity at a 200th cycle to the discharge capacity at the second cycle was defined as the capacity retention rate.

The batteries were charged under the above charging conditions and the thickness of each of the batteries was measured after the charging of the first cycle had ended. A change in thickness of each of the batteries was determined from the difference from the thickness (4 mm) before the charging.

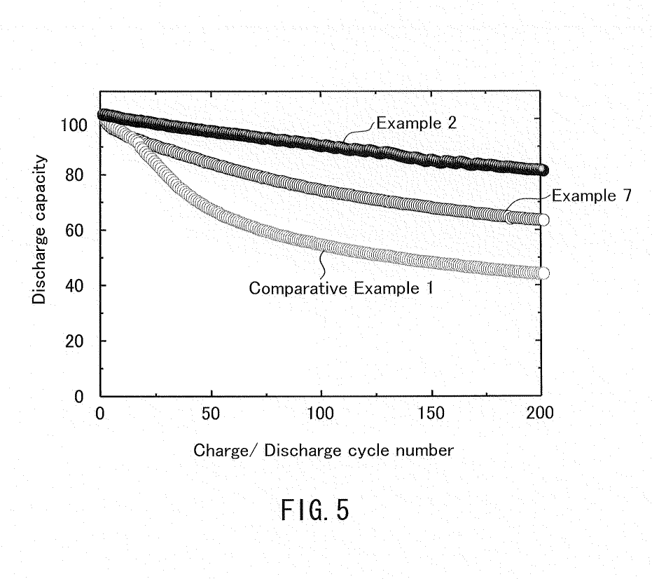

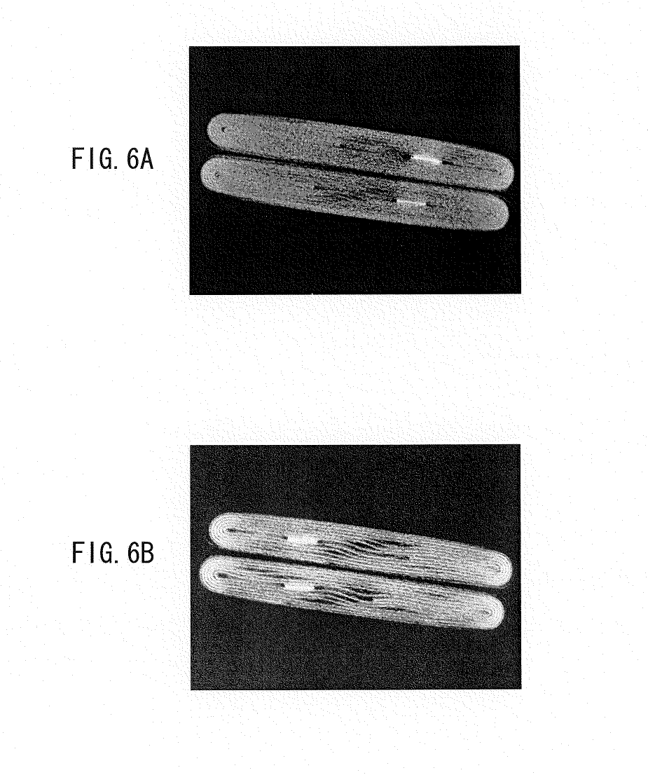

Table 1 shows the results of measuring the respective points. Further, FIG. 5 shows a change in discharging capacity of the nonaqueous secondary batteries in Examples 2 and 7 and Comparative Example 1 at each charge/discharge cycle. Furthermore, FIG. 6A shows an X-ray CT (computed tomography) image of a transverse section of the nonaqueous secondary battery of Example 2 after one cycle, and FIG. 6B shows an X-ray CT image of a transverse section of the nonaqueous secondary battery of Example 7 after one cycle.

In the graph of FIG. 5, the horizontal axis indicates charge/discharge cycles and the vertical axis indicates a relative value of discharge capacity at each cycle when the discharge capacity at the second cycle is 100.

TABLE 1

| | configuration of | | | battery evaluation | | |
|---|---|---|---|---|---|---|
| | negative electrode | | | change in | discharge | capacity |
| | active | | | thickness | capacity | retention |
| | material | binder | coating layer | (mm) | (mAh) | rate (%) |
| Example 1 | SiO | polyamideimide | no | 0.45 | 900 | 75 |
| Example 2 | SiO | polyamideimide | yes | 0.40 | 900 | 80 |
| Example 3 | SiO | polyamideimide | no | 0.40 | 900 | 80 |
| Example 4 | Si | polyamideimide | no | 0.55 | 1050 | 60 |
| Example 5 | SiO | polyamideimide | yes | 0.35 | 900 | 85 |
| Example 6 | SiO | polyamideimide | yes | 0.30 | 850 | 85 |
| Example 7 | SiO | polyimide | no | 0.50 | 900 | 60 |
| Comparative | SiO | PVDF | no | 0.60 | 900 | 40 |
| Example 1 | | | | | | |

As can be seen from Table 1 and FIG. 5, the nonaqueous secondary batteries of Examples 1 to 7 had a high capacity and also had a smaller change in their thickness and higher capacity retention rate after repeated charging and discharging, in comparison with the nonaqueous secondary battery of Comparative Example 1. That is, it was confirmed that they had favorable battery characteristics. Further, as can be seen from FIGS. 6A and 6B, regarding the electrode body in the battery of Example 2 in which the coating layer was provided, the electrode body was prevented from becoming deformed in comparison with that in the battery of Example 7 in which the negative electrode was not provided with a coating layer. Further, by using the above-described polyamideimide as the binder, the strength of the negative electrode mixture layer was able to be enhanced even by a heat treatment at a low temperature of 200° C. or less, and the batteries with favorable characteristics were able to be formed.

The invention may be embodied in other forms without departing from the spirit of essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

### INDUSTRIAL APPLICABILITY

As described above, according to the present invention, by preventing bending of the electrode associated with charging and discharging, and thereby avoiding the swelling of the battery, it is possible to provide a nonaqueous secondary battery having a high capacity and favorable charge/discharge cycle characteristics. The nonaqueous secondary battery of the present invention can be preferably used for a variety of application purposes, including a power supply for small and multifunctional portable devices, for which conventional nonaqueous secondary batteries have been used.

1. A nonaqueous secondary battery electrode comprising a mixture layer and a porous layer formed on a surface of the mixture layer,
wherein the mixture layer includes:
an electrode material that is expressed by a composition formula SiOₓ where x in the composition formula satisfies 0.5≦x≦1.5, a conductive material, and
at least one binder selected from a group consisting of polyimide, polyamideimide and polyamide, and
the porous layer includes an insulating material unreactive with Li.

2. The nonaqueous secondary battery electrode according to claim 1, wherein the binder has an aromatic ring in its molecular chain.

3. The nonaqueous secondary battery electrode according to claim 1, wherein the conductive material is a carbon material.

4. The nonaqueous secondary battery electrode according to claim 1, wherein the electrode material and the conductive material form a complex.

5. The nonaqueous secondary battery electrode according to claim 4, wherein a surface of the electrode material is coated with the conductive material.

6. The nonaqueous secondary battery electrode according to claim 4, wherein the electrode material and the conductive material form a granulate.

7. The nonaqueous secondary battery electrode according to claim 4, wherein a surface of the complex is further composited with a different conductive material.

8. The nonaqueous secondary battery electrode according to claim 1, wherein a thickness of the porous layer is 1 to 10 μm.

9. The nonaqueous secondary battery electrode according to claim 1, wherein the insulating material is an aluminum oxide.

10. The nonaqueous secondary battery electrode according to claim 1, wherein the porous layer further includes a binder.

11. The nonaqueous secondary battery electrode according to claim 10, wherein the binder is at least one selected from a group consisting of polyimide, polyamideimide, and polyamide.

12. A method of producing an electrode, comprising steps of:
applying a mixture-containing slurry containing an electrode material, a conductive material and polyamideimide to a surface of a current collector and drying the applied slurry to faun a coating;
forming a mixture layer by compression molding the coating; and
subjecting the mixture layer to a heat treatment at a temperature of 100° C. or more and 200° C. or less.

13. The method of producing an electrode according to claim 12, wherein the electrode material includes an electrode material expressed by a composition formula SiOₓ where x in the composition formula satisfies 0.5≦x≦1.5.

14. The method of producing an electrode according to claim 12, wherein the conductive material is a carbon material.

15. The method of producing an electrode according to claim 12, further comprising a step of forming a porous layer containing an insulating material unreactive with Li on a surface of the mixture layer.

16. The method of producing an electrode according to claim 15, wherein the porous layer further includes a binder.

17. The method of producing an electrode according to claim 15, wherein the insulating material is an aluminum oxide.

18. The method of producing an electrode according to claim 15, wherein a thickness of the porous layer is 1 to 10 μm.

19. The method of producing an electrode according to claim 12, wherein the heat treatment is carried out under a reduced pressure.

20. A nonaqueous secondary battery comprising a positive electrode, a negative electrode and a nonaqueous electrolyte,
wherein the negative electrode is the nonaqueous secondary battery electrode according claim 1.
